(19) United States
(12) Patent Application Publication
(10) Pub. No.: US 2015/0310758 A1
(43) Pub. Date: Oct. 29, 2015

(54) SYSTEMS, METHODS, AND APPARATUS FOR GENERATING CUSTOMIZED VIRTUAL REALITY EXPERIENCES

(71) Applicant: The Travelers Indemnity Company, Hartford, CT (US)

(72) Inventors: Amy E. Daddona, Southington, CT (US); Henry F. Edinger, Tolland, CT (US); Sean D. Martin, Portland, OR (US); Nirmal Traeger, Eagan, MN (US); Scott D. Humphrey, Wethersfield, CT (US); Audra L. Ransford, Hartford, CT (US)

(21) Appl. No.: 14/696,148

(22) Filed: Apr. 24, 2015

Related U.S. Application Data
(60) Provisional application No. 61/984,763, filed on Apr. 26, 2014.

(51) Int. Cl. G09B 9/02; G09B 9/24; G09B 9/052; G09B 9/06; G06F 3/01; G09B 9/05

(52) U.S. Cl. CPC G09B 9/02; G06F 3/013; G09B 9/05; G09B 9/052; G09B 9/063; G09B 9/24

(57) ABSTRACT

Systems, apparatus, methods, and articles of manufacture provide for generating customized virtual reality experiences based on information associated with a user or other entity, including, for example, distraction information associated with a previous driving session of a user.

### BACKGROUND

Virtual reality (VR) and virtual environment systems allow users to interact with immersive, 3-D virtual reality simulations. A virtual reality environment may be configured, for example, to provide a simulated environment that users may interact with in real time and which may be responsive to, for example, a user's motions or other types of actions. The advantages of using virtual reality systems to train and educate users are well known. However, despite the advantages of virtual reality systems for providing educational experiences, previous systems and practices have failed to provide for an optimized and/or automated ability to generate customized virtual reality experiences or presentations.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a diagram of a system according to an embodiment of the present invention;

FIG. 2 is a diagram of a system according to an embodiment of the present invention;

FIG. 3 is a diagram of a computing device according to an embodiment of the present invention;

FIG. 4 is a diagram of a computing device according to an embodiment of the present invention;

FIG. 5 is an example representation of a database according to an embodiment of the present invention;

FIG. 6 is a flowchart of a method according to an embodiment of the present invention;

FIG. 7 is a flowchart of a method according to an embodiment of the present invention;

FIG. 8 is a flowchart of a method according to an embodiment of the present invention;

FIG. 9 is a flowchart of a method according to an embodiment of the present invention;

FIG. 10 is a flowchart of a method according to an embodiment of the present invention;

FIG. 11A is an example interface according to an embodiment of the present invention; and

FIG. 11B is an example interface according to an embodiment of the present invention.

### DETAILED DESCRIPTION

The inventors have recognized that, in accordance with some embodiments described in this disclosure, some types of users, clients, and businesses may find it beneficial to utilize a system for rendering virtual environments customized in accordance with particular characteristics of customers, employees, contractors, and/or other types of users.

The inventors have recognized that, in accordance with some embodiments described in this disclosure, some types of entities (e.g., individual users or customers, or business customers, such as a company or store) may find it beneficial to utilize a system for creating immersive virtual experiences for certain users in order to inform and educate the employees and other types of users about unsafe behavior with respect to a respective business (e.g., behavior that may result in injury, property damage, and/or other types of losses or damage).

The inventors have recognized that virtual environments customized with one or more scenarios specific to a particular business, such as a particular factory, warehouse, or store, may heighten users' awareness and sensitivity to accident prevention, injury prevention, and other safety concerns. The inventors have recognized that customized virtual reality environments allow for accelerated training of users (e.g., employees, executives, customers, and other users associated with a particular business) and may reduce or prevent injuries or other damages.

According to some embodiments, a customized virtual reality application may be used advantageously as a tool to improve a business's costs (e.g., reducing costs or potential costs due to damage, injury, inefficiency, etc.) by providing for one or more of: (i) virtual engagement by users with a simulation of that business owner's own business environment; (ii) education about a variety of products, services, and/or procedures that may be relevant to the business's particular situation; and/or (iii) testing of one or more simulated scenarios to inform various types of VR users about current processes and decision-making of a business (e.g., in order to resolve and/or improve current behaviors and reduce future losses).

In accordance with some embodiments, accelerated training may be completed in a safe environment to educate employees on exposures in the workplace and/or proper techniques for job performance. In some embodiments, a cost-efficient training application may be provided in a manner that makes it accessible across multiple locations and to users having ranges of physical capabilities. Immersive, virtual training may provide for longer retention of simulated subject matter, relative to other forms of training, while potentially improving health and safety, and reducing a business's loss costs. Further, inventors have recognized, in accordance with some embodiments, that analyzing the behaviors of customers, employees, and other types of users in a customized virtual embodiment may inform the development of solutions promoting safety and the reduction of loss exposure (e.g., by alerting an employee when the employee is engaging in risky behaviors in the simulated environment).

In accordance with some embodiments of the present invention, one or more systems, apparatus, methods, articles of manufacture, and/or computer readable media (e.g., a non-transitory computer readable memory storing instructions for directing a processor) provide for one or more of:

a) training programs (e.g., customized training simulations rendered based on the most frequent injury scenarios experienced by a business) for employees, customers, and other types of users;

b) alerting or warning the user when engaging in risky behavior in a simulated environment;

c) proactive training programs to expose employees and other types of users to various business-specific scenarios (e.g., generally typical for the type and/or location of the business);

d) data analysis and/or forecasting of trends in user behavior based on information (e.g., virtual reality session data) about users' virtual reality experiences in simulated environments; and/or

e) developing products, services, and/or processes to address future risks and exposures.

Some embodiments provide for generating and/or presenting various types of driving simulations. Although various embodiments may be described in this disclosure with respect to driving automobiles, it will be readily understood that driving simulations are not so limited and may comprise simulations for operating any of various types of vehicles (e.g., cars, trucks, buses), large or heavy equipment (e.g., cranes, excavators, other construction equipment), aircraft, trains, subways, and/or other vessels (e.g., boats, ferries). In accordance with some embodiments of the present invention, one or more systems, apparatus, methods, articles of manufacture, and/or computer readable media (e.g., a non-transitory computer readable memory storing instructions for directing a processor) provide for one or more of:

a) driving simulations directed to educating users about, and/or acclimating them to, various types of unpredictable driving/operational scenarios;

b) driving simulations directed to educating users about the effects on driving of driver fatigue, the driver's condition (e.g., age, exercise, eating habits), driver distractions, weather conditions, hazardous road and/or other operating conditions, and/or various vehicle types, sizes, and cargo loads; and/or

c) monitoring, detecting, and/or analyzing users' behavior and/or driving patterns (in the virtual environment) in response to various types of driving scenarios and/or driving conditions.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting.

As used herein, the term “user” may generally refer to any type, quantity, and/or manner of individual that uses a virtual reality presentation system, as described with respect to various embodiments in this disclosure.

Some embodiments described herein are associated with a “user device,” “customer device,” or a “network device.” As used herein, a customer device is a subset of a user device, and a user device is a subset of a network device. The network device, for example, may generally refer to any device that can communicate via a network, while the user device may comprise a network device that is owned or operated by or otherwise associated with any type of user (e.g., a developer of a virtual reality application, a user of a virtual reality application), and a customer device may comprise a network or user device that is owned or operated by or otherwise associated with a customer. Examples of user and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. User, customer, and/or network devices may comprise one or more network components.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium, such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

In cases where video signals or large files are being sent over the network, a broadband network may be used to alleviate delays associated with the transfer of such large files, however, such an arrangement is not required. Each of the devices may be adapted to communicate on such a communication means. Any number and type of machines may be in communication via the network. Where the network is the Internet, communications over the Internet may be through a website maintained by a computer on a remote server or over an online data network, including commercial online service providers, and/or bulletin board systems. In yet other embodiments, the devices may communicate with one another over RF, cable TV, and/or satellite links. Where appropriate, encryption or other security measures, such as logins and passwords, may be provided to protect proprietary or confidential information.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

As used herein, the term “customer” or “business customer” may generally refer to any type, quantity, and/or manner of entity that is a customer of another entity. A customer may comprise a business or personal insurance policy holder (and/or employees, agents, and/or other personnel associated with the customer), for example. Although examples of business customers that are customers of an insurance company may be used in describing some examples of embodiments discussed in this disclosure, such examples are not limiting and other types of customers and their product- and/or service-providers may make advantageous use of the described embodiments. A customer may have an existing business relationship with other entities described herein, such as an insurance company for example, or may not yet have such a relationship. For instance, a customer may comprise a “potential customer” (e.g., in general and/or with respect to a specific product offering). A customer is one type of user; other types of users may include, for example, an agent, virtual reality developer, claim handler, underwriter, risk manager, and/or other employee or personnel of an entity providing customized virtual reality environments to its customers.

As used herein, “determining” includes calculating, computing, deriving, looking up (e.g., in a table, database, or data structure), ascertaining, and/or recognizing.

As used herein, “processor” means any one or more microprocessors, Central Processing Unit (CPU) devices, computing devices, microcontrollers, and/or digital signal processors. As used herein, the term “computerized processor” generally refers to any type or configuration of primarily non-organic processing device that is or becomes known. Such devices may include, but are not limited to, computers, Integrated Circuit (IC) devices, CPU devices, logic boards and/or chips, Printed Circuit Board (PCB) devices, electrical or optical circuits, switches, electronics, optics and/or electrical traces. As used herein, “mechanical processors” means a sub-class of computerized processors, which may generally include, but are not limited to, mechanical gates, mechanical switches, cogs, wheels, gears, flywheels, cams, mechanical timing devices, etc.

As used herein, the terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “non-transitory” and/or “tangible,” when used in reference to computer-readable media or memories, specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards, or protocols. For a more exhaustive list of protocols, the term “network” is defined above and includes many exemplary protocols that are also applicable here.

In some embodiments, one or more specialized machines, such as a computerized processing device, a server, a remote terminal, and/or a customer device, may implement one or more of the various practices described in this disclosure.

A computer system of an insurance company may, for example, comprise various specialized computers that interact to generate and present virtual reality simulations to one or more types of users, as described in this disclosure.

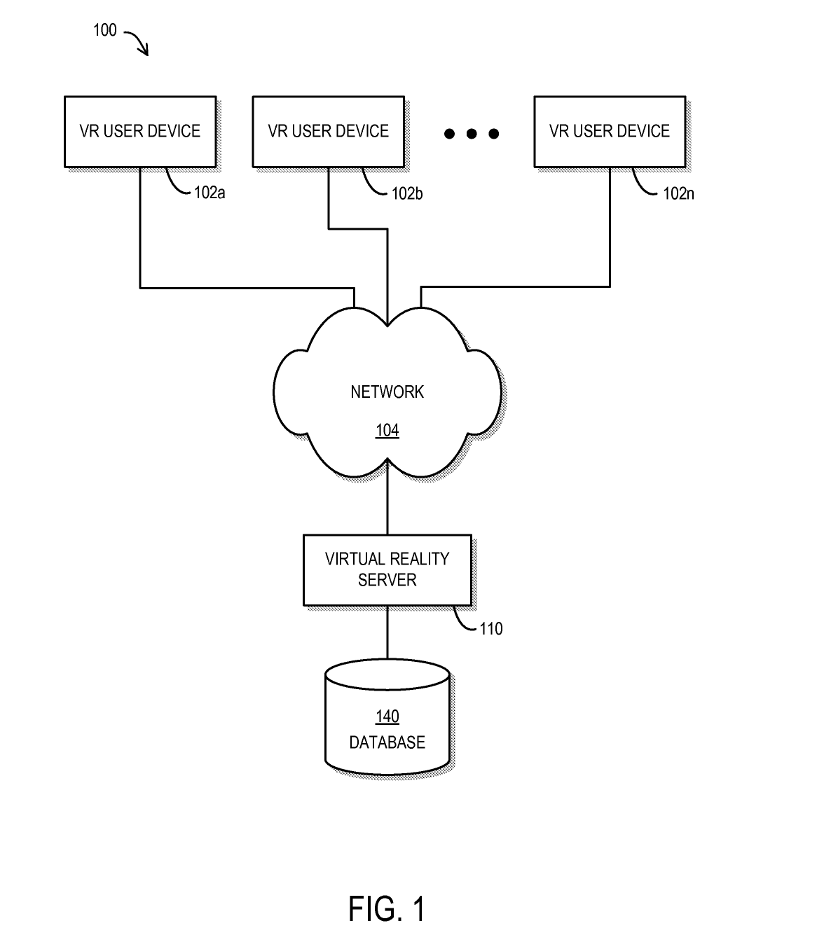

Turning first to FIG. 1, a block diagram of a system 100 according to some embodiments is shown. In some embodiments, the system 100 may comprise a plurality of virtual reality (VR) user devices 102a-n in communication with and/or via a network 104. In some embodiments, a virtual reality server 110 may be in communication with the network 104 and/or one or more of the VR user devices 102a-n. In some embodiments, the virtual reality server 110 (and/or the VR user devices 102a-n) may be in communication with a database 140. The database 140 may store, for example, data associated with customers and/or one or more claims related to customers (e.g., insurance customers) owning and/or operating the VR user devices 102a-n, and/or instructions that cause various devices (e.g., the virtual reality server 110 and/or the VR user devices 102a-n) to operate in accordance with embodiments described in this disclosure.

The VR user devices 102a-n, in some embodiments, may comprise any type or configuration of electronic, mobile electronic, and or other network and/or communication devices (or combinations thereof) that are or become known or practicable. The first user device 102a may, for example, comprise one or more: PC devices; computer workstations (e.g., underwriter workstations); VR system input devices and/or VR system output devices, such as the Gear VR™ VR headset and/or the Galaxy Note 4, both by Samsung Electronics (e.g., with VR content developed using the Oculus™ Mobile Software Development Kit (SDK) for VR by Oculus VR, LLC), or the Project Morpheus™ VR headset by Sony Corporation; tablet computers, such as an iPad® manufactured by Apple®, Inc. of Cupertino, Calif.; and/or cellular and/or wireless telephones, such as a Galaxy S6™ by Samsung Electronics, an iPhone® (also manufactured by Apple®, Inc.), or a G3™ smart phone manufactured by LG® Electronics, Inc. of San Diego, Calif., and running the Android® operating system from Google®, Inc. of Mountain View, Calif. In some embodiments, one or more of the VR user devices 102a-n may be specifically utilized and/or configured (e.g., via specially-programmed and/or stored instructions, such as may define or comprise a software application) to communicate with the virtual reality server 110 (e.g., via the network 104).

The network 104 may, according to some embodiments, comprise LAN, WAN, cellular telephone network, Bluetooth® network, NFC network, and/or RF network with communication links between the VR user devices 102a-n, the virtual reality server 110, and/or the database 140. In some embodiments, the network 104 may comprise direct communications links between any or all of the components 102a-n, 110, 140 of the system 100. The virtual reality server 110 may, for example, be directly interfaced or connected to the database 140 via one or more wires, cables, wireless links, and/or other network components, such network components (e.g., communication links) comprising portions of the network 104. In some embodiments, the network 104 may comprise one or many other links or network components other than those depicted in FIG. 1. The second user device 102b may, for example, be connected to the virtual reality server 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 110, 140 of the system 100. The network 104 may comprise one or more cellular telephone networks with communication links between the VR user devices 102a-n and the virtual reality server 110, for example, and/or may comprise the Internet, with communication links between the VR user devices 102a-n and the database 140, for example.

According to some embodiments, the virtual reality server 110 may comprise a device (or system) owned and/or operated by or on behalf of or for the benefit of an insurance company. The insurance company may utilize customer information, claim information, loss information (e.g., information about insured losses associated with a customer), and/or virtual reality information (e.g., virtual reality objects for simulating environments) in some embodiments, to manage, generate, analyze, select, and/or otherwise determine information for use in rendering customized virtual reality experiences for customers.

In some embodiments, the insurance company (and/or a third-party, not explicitly shown) may provide an interface (not shown in FIG. 1) to and/or via the VR user devices 102a-n. The interface may be configured, according to some embodiments, to allow and/or facilitate access to customized virtual reality programs, modules, and/or experiences, by one or more customers and/or other types of users. In some embodiments, the system 100 (and/or the virtual reality server 110) may present customized virtual environments and/or scenarios based on insurance customer information (e.g., from the database 140), loss data, geospatial data, and/or telematics data.

In some embodiments, the database 140 may comprise any type, configuration, and/or quantity of data storage devices that are or become known or practicable. The database 140 may, for example, comprise an array of optical and/or solid-state hard drives configured to store data and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the VR user devices 102a-n may comprise the database 140 or a portion thereof, for example, and/or the virtual reality server 110 may comprise the database 140 or a portion thereof.

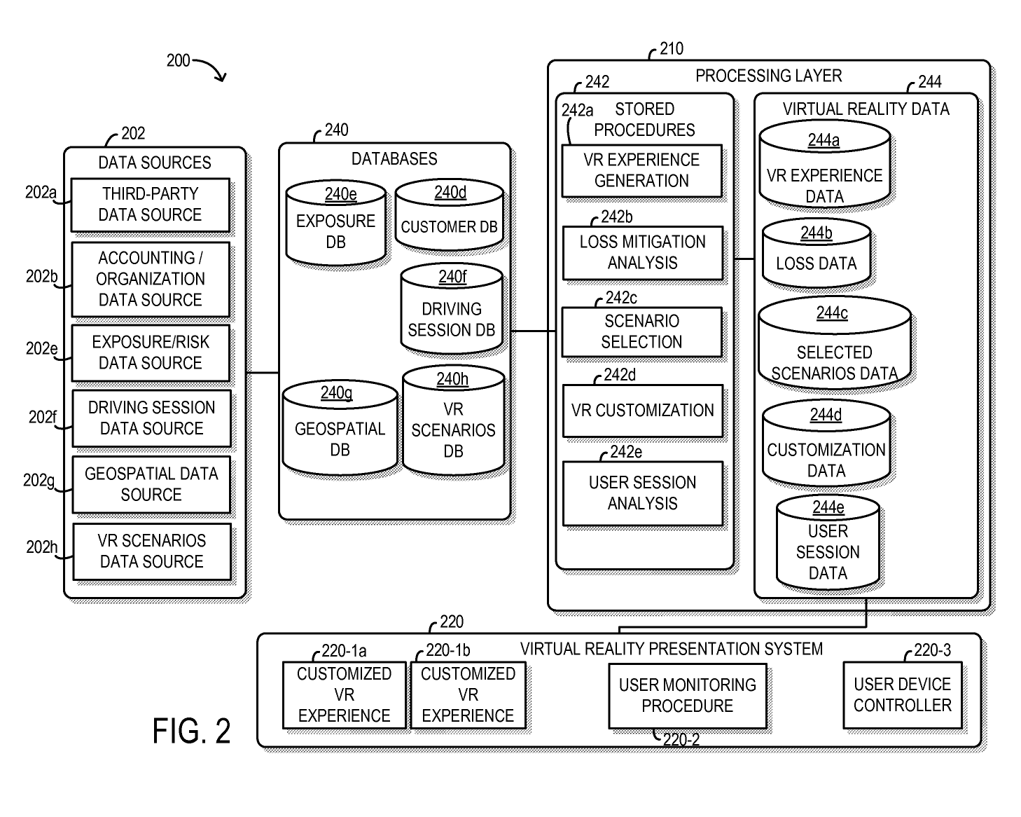

Referring now to FIG. 2, a block diagram of a system 200 according to some embodiments is shown. In some embodiments, the system 200 may comprise a plurality of data sources 202, a processing layer 210, a virtual reality presentation system 220, and/or a plurality of databases 240. In some embodiments, the system 200 and/or the processing layer 210 may comprise a plurality of stored procedures 242. According to some embodiments, any or all of the components 202, 210, 220, 240, 242 of the system 200 may be similar in configuration and/or functionality to any similarly named and/or numbered components described in this disclosure. Fewer or more components 202, 210, 220, 240, 242 (and/or portions thereof) and/or various configurations of the components 202, 210, 220, 240, 242 may be included in the system 200 without deviating from the scope of embodiments described herein. Any component 202, 210, 220, 240, 242 depicted in the system 200 may comprise a single device, a combination of devices and/or components 202, 210, 220, 240, 242, and/or a plurality of devices, as is or becomes desirable and/or practicable. Similarly, in some embodiments, one or more of the various components 202, 210, 220, 240, 242 may not be needed and/or desired in the system 200.

According to some embodiments, any or all of the data sources 202 may be coupled to, configured to, oriented to, and/or otherwise disposed to provide and/or communicate data to one or more of the databases 240. A third-party data source 202a (e.g., an external telematics data source, simulated driving data source, and/or geospatial data source), an accounting / organization data source 202b, an exposure/risk data source 202e, a driving session data source 202f, a geospatial data source 202g, and/or a virtual reality (VR) scenarios data source 202h may, for example, provide data that may be fed into one or more of a customer database 240d, an exposure database 240e, a driving session database 240f, a geospatial database 240g, and/or a VR scenarios database 240h.

According to some embodiments, driving session data source 202f may comprise a source of information about at least one driving session of one or more drivers. In some embodiments, driving session data source 202f may provide one or more of the following types of information associated with one or more virtual and/or real word driving sessions, some or all of which information may be stored in driving session database 240f: telematics data, driving conditions data, environmental conditions data, environmental obstacles data, data about buildings and other structures, road conditions data, vehicle data, and/or driver distraction data.

According to some embodiments, telematics data and/or driver distraction data may include, without limitation, information about one or more of the following: vehicle speed, a driver's breaking behavior, a driver's signaling behavior, a driver's body posture, a driver's hand location(s), a vehicle's radio volume, a driver's eye path or view, a driver's following distance to other cars, a number of miles to travel and/or traveled, a driver's mobile device use, other vehicles or hazards nearby, etc.

In one embodiment, driver distraction data may include indications (e.g., audio, video, or any other type of electronic information) indicative of instances and/or analysis of distracted driving during a driving session. For example, driver distraction data may be determined by analyzing information (e.g., audio and/or video recorded during a real or simulated driving session of a particular driver), including an indication of one or more of:
whether the driver's eye gaze shifted from an appropriate view (e.g., generally forward looking, or a view of the road and/or traffic ahead) to an inappropriate view (e.g., the driver looked at a smartphone, stereo, display screen, or other type of object internal or external to the vehicle being driven)
whether the driver's eye gaze was diverted from an appropriate view for more than a predetermined period of time (e.g., the driver looked too long out of a side window during a time when the driver should have been looking at the road ahead)
the driver's actual view during a previous driving session (e.g., what the driver was actually looking at some point during a driving session)
a driving error made by the driver during a previous driving session (e.g., the driver erroneously took and/or failed to take a particular action)
an action taken by the driver during a previous driving session (e.g., the driver turned around to see something in the back seat; the driver turned a volume on a stereo to a high volume; the driver sent a text message while driving)
an object interacted with by the driver during a previous driving session (e.g., the driver looked at a smartphone; the driver was consuming food or drink)

In some embodiments, the data stored in any or all of the databases 240 may be utilized by the processing layer 210. The processing layer 210 may, for example, execute and/or initiate one or more of the stored procedures 242 to process the data in the databases 240 (or one or more portions thereof) and/or to define one or more tables or other types of data stores (e.g., for use in generating a customized VR experience and/or presenting information via the virtual reality presentation system 220). In some embodiments, the stored procedures 242 may comprise one or more of VR experience generation procedure 242a, loss mitigation analysis procedure 242b, scenario selection procedure 242c, VR customization procedure 242d, and/or user session analysis procedure 242e.

According to some embodiments, the execution of the stored procedures 242a-e may define, identify, calculate, create, reference, access, update and/or determine one or more data tables or other data stores. In some embodiments, one or more of the databases 240 and/or associated data tables 244a-e determined via one or more of stored procedures 242a-e may store information about one or more virtual reality experiences and/or one or more features of the virtual reality presentation system 220 (e.g., customized VR experiences 220-1a-b). Accordingly, any references to databases 240 in describing various embodiments in this disclosure may be understood as applying to, alternatively or in addition, one or more data stores 244a-e.

According to some embodiments, VR experience generation procedure 242a may be configured to control and/or execute one or more of loss mitigation analysis procedure 242b, scenario selection procedure 242c, and/or VR customization procedure 242d, and/or may be configured to determine and/or store VR experience data 244a defining one or more customized VR experiences.

In some embodiments, the data from one or more data sources 202 may comprise data descriptive of, assigned to, and/or otherwise associated with a customer (or group of customers, such as in a particular business industry) and/or with one or more insurance claims and/or losses. For example, in some embodiments directed to business customers and/or insurance customers, data sources 202 may comprise a customer data source, an employee data source, a policy data source, and/or a claim/loss data source. Similarly, in some embodiments databases 240 may comprise, a customer database, an employee database, a claim database (e.g., a database of insurance claim information), a workers compensation (“comp”) database, an automobile insurance database, a general liability insurance database, a property insurance database, and/or a claim history database. In one embodiment, loss mitigation analysis procedure 242b operates to conduct one or more queries on claim data, claimant data, claim history data, exposure database 240e, and/or driving session database 240f, in order to identify one or more primary causes of loss or loss drivers for a customer or industry.

In one or more embodiments, loss mitigation analysis procedure 242b may include instructions to direct a processor of a computerized processing device to analyze claim and/or loss data in order to identify one or more factors or risk scenarios contributing more prominently to the loss experience of one or more customers. One or more different data queries may be conducted in order to derive information for a particular customer, loss type, industry, and/or Standard Industry Classification (SIC) code. For example, loss data may be analyzed to identify circumstances or characteristics that are most common in terms of the frequency, cost, and/or severity of loss for a given customer or industry. Identifying the “most common” types of losses may comprise, for example, determining a total number of claims having a particular type of loss and/or determining a percentage of the total claims having one or more particular factors in common. One or more VR scenarios may be selected (e.g., from VR scenarios database 240h) that correspond to the identified loss characteristics. Alternatively, or in addition, in one or more embodiments, one or more other types of factors may be identified by VR customization procedure 242d for use in customizing a VR experience for a customer. Some examples of information that may be analyzed and/or identified (e.g., by loss mitigation analysis procedure 242b and/or VR customization procedure 242d) for determining loss mitigation customizations and/or other types of VR customizations include, without limitation, one or more of:
Accident Cause—VR experiences may be customized by including VR scenarios that correspond to the most common accident causes
Body Part—VR experiences may be customized by including VR scenarios that correspond to the most common parts of the body involved in claims for a given customer or industry
Injury Types—VR experiences may be customized by including VR scenarios that correspond to the most common types of injuries associated with claims—injury types may be described generally (e.g., fall or slip) and/or as specifically as deemed desirable (e.g., fall or slip from a ladder, fall or slip on ice or snow)
Claimant Age Grouping—Claimant age may be used, for example, to design VR experiences (e.g., by utilizing customizations and/or scenarios relevant to an older worker population)
Diagnosis Grouping—Claims may be grouped by like diagnosis codes (e.g., for workers compensation claims) to identify common diagnoses
Gender—Gender of claimants (e.g., for workers compensation claims) may be used to customize the design of a VR experience (e.g., by accounting in the simulation for the average height of claimants)
Job Class Code—VR experiences may be customized to include scenarios and/or settings consistent with the job classes most commonly involved in accidents
Occupation—VR experiences may be customized to include scenarios and/or settings consistent with the occupations more likely to cause a loss
Length of Employment—VR experiences may be customized to target participants based on the length of time between date of hire and accident date (e.g., customization for new hires)
Location/Geographical Jurisdiction—VR experiences may be customized based on certain geographical jurisdictions (e.g., state, county, town) and/or workplace, such as by generating a virtual representation of a particular setting (e.g., using geospatial data describing a customer's place of business in geospatial database 240g)
Time of Accident—VR experience could vary based on time of day typical of common accidents

According to some embodiments, overall common industry trends may be analyzed (e.g., based on industry codes, such as SIC or North American Industry Classification System (NAICS) codes).

In some embodiments, one or more of customized VR experiences 220-1a-b may comprise one or more VR scenarios, selected from VR scenarios database 240h and stored in selected scenarios data 244c by scenario selection procedure 242c, based on loss data 244b. In some embodiments, loss data 244b may be derived by loss mitigation analysis procedure 242b by identifying (e.g., based on exposure database 240e and/or claim history data) one or more leading causes of loss for a particular customer and/or industry of a customer. For example, one or more VR scenarios (e.g., metal cutting, operating a forklift, lifting heavy materials, working in close proximity to sharp objects) may be selected that correspond to the most common types of accidents in order to provide a customized VR experience, relevant to a customer's business and exposures, designed to educate target customers and their employees about how to avoid similar types of accidents in the future.

According to some embodiments, loss mitigation analysis procedure 242b may be configured to identify key loss drivers (e.g., for a business) based on information, such as loss history and/or industry data, provided by industry organizations or government agencies. In one example, if the analysis determines that one key loss driver is injury resulting from contact with equipment, then a VR experience may be generated (e.g., by selecting particular virtual settings and/or scenarios) with the following features: (i) a simulated work area that has the participant in close proximity to equipment, and (ii) a simulated work area that has the participating user operating simulated heavy equipment where misuse could lead to injury.

Some examples of major losses and/or more prominent causes of loss may include one or more of: determining whether a total loss amount (e.g., for claims having one or more particular characteristics) is greater than a predetermined threshold amount and/or whether the ratio of a total number of incidents in a particular period of time (e.g., a month, a year) is greater than a predetermined threshold ratio.

In one example, the respective VR experiences generated for two shipping companies may differ based on what each shipping companies actually ships. This will change, for example, the way employees interact with objects. For example, if an item can be lifted, then the VR experience may focus on proper lifting techniques. If, on the other hand, the object being shipped needs to be moved using equipment, then the generated VR experience may focus on how to properly use the equipment. Experience can also differ as the warehouses may be set up differently and involve different procedures that may cause the underlying risks to differ.

According to some embodiments, a VR scenario and/or VR experience may include a training program. A training program may be generated, as discussed in this disclosure, based on the most frequent injuries experienced by the customer and/or experienced in the customer's industry. In one example, a proactive VR experience may include one more training programs, such as ergonomics, to prevent the most frequent injury scenarios, by demonstrating recommended ergonomic practices (e.g., proper lifting techniques, correct driving posture). Other examples of training programs may include VR experiences involving equipment operation and/or the prevention of slips and falls. VR experiences may be customized to vary based on sub-industry (e.g., metal manufacturers may focus on hot work examples vs. a wood manufacturer may focus on concerns about employees coming into contact with sharp objects).

In some embodiments, VR customization procedure 242d may be configured to generate customization data 244d for use (e.g., by VR experience generation procedure 242a) in creating customized VR experiences 220-1a-b. For example, geospatial database 240g may include plan data (e.g., a diagram, computer aided design (CAD) drawing, or other virtual representation of spaces) representing a business's physical layout.

In one embodiment, VR experience generation procedure 242a may be configured to generate virtual objects based on selected scenarios data 244c and/or customization data 244d to generate a virtual reality simulation presented to a user via virtual reality presentation system 220.

According to some embodiments, the virtual reality presentation system 220 may comprise a user monitoring procedure 220-2 for monitoring, analyzing, storing, and/or transmitting signals received from a user of the VR presentation system 220 (e.g., for reviewing users' responses to interactive environments). User session data 244e may include information received from user monitoring procedure 220-2 regarding how a given user is interacting with the virtual environment, and may be analyzed and/or derived by user session analysis procedure 242e (e.g., to identify trends in user behavior in the simulated environment(s), driving patterns, etc.).

According to some embodiments, user session data 244e may be used to develop the next version of the VR experience generation procedure 242a (e.g., by incorporating user feedback to one or more VR experiences). Also, insurance professionals may be able to improve a customer-facing experience while increasingly demonstrating expertise through a better understanding of processes related to loss, such as injury recovery. In one embodiment, user session data 244e may include one or more answers to a survey (e.g., provided in a VR experience and/or in real life) used to capture feedback from users. In one embodiment, users may indicate an emerging trend or behavior pattern, and a VR experience may be updated consistent with the emerging trend.

According to some embodiments, user actions taken during participation in a VR experience may be used with respect to customer rating and/or premium determinations. According to some embodiments, underwriters and/or other types of insurance professionals may experience the exposures virtually to inform underwriting decisions using data, such as flood, crime, and municipal level data in an environment overlaid without associated risks. According to some embodiments, a user's VR experience and behavior in the VR experience may be analyzed (e.g., by user session analysis procedure 242e) to inform and/or highlight previously unknown risks within a particular industry, business segment, and/or personal insurance exposure, and may potentially influence future product and/or rating decisions.

According to some embodiments, the virtual reality presentation system 220 may comprise a user device controller 220-3 for controlling one or more types of input and/or output devices utilized in the virtual reality presentation system 220 to provide a virtual reality experience to the user, and/or to respond to actions of the user in the virtual environment (e.g., in response to signals indicating motion of the user received via a head-mounted display (HMD)). In some embodiments, virtual reality presentation system 220 may comprise one or more computer systems and/or computer-readable storage devices (not shown) for executing a virtual reality presentation program (not shown) in order to provide the customized VR experiences 220-1a-b.

According to some embodiments, each customized VR experience 220-1a-b may include one or more programmatic objects (e.g., a simulated wall, vehicle, vehicle controls, worker, or shipping box) that may be configured to respond to user interaction as part of the virtual reality simulation. User monitoring procedure 220-2 may be configured to record interactions of a user with the programmatic virtual objects and environment. User devices may comprise, in some embodiments, HMDs, eye-tracking devices, motion- and/or pressure-sensing gloves, and the like. Other types of user input devices for virtual environments are well known.

According to one example implementation, loss mitigation analysis procedure 242b may be configured to identify a particular customer's top five most common claims. The analysis may include reviewing one or more of: account specific loss data (e.g., use loss data to understand what areas the VR experience should focus on), claim data (e.g., claim history to identify major loss causes), risk data, third-party data (e.g., industry trends/statistics identifying top causes of injuries within the industry and/or sub-industry), geospatial data (e.g., information representation a physical business location of the customer), and/or telematics data.

In some embodiments, telematics data and other types of driving session data (e.g., stored in driving session database 240f) may be used to develop a customized VR experience incorporating various weather conditions, distractions, hazards, and/or unexpected scenarios relevant to different types of drivers. In one embodiment, the VR experience will vary based on the typical travel duration/time for a customer's employees (e.g., incorporate a fatigue simulation), driving conditions, and/or type of vehicle used (e.g., standard vehicle compared to oversized truck). In some embodiments, the VR experience may be based on and/or may represent one or more distractions and/or other conditions (e.g., fatigue) experienced by a driver in a previous (real or simulated) driving session. For example, a particular driver's distracted driving habits may be used, in some embodiments, to generate a virtual driving simulation that may be presented to one or more VR users (one of whom may be the driver on which the simulation is based). In this way, a VR user may benefit from being presented with a simulation of the effect of certain actions while driving on a driver's ability to drive safely and in an appropriate manner.

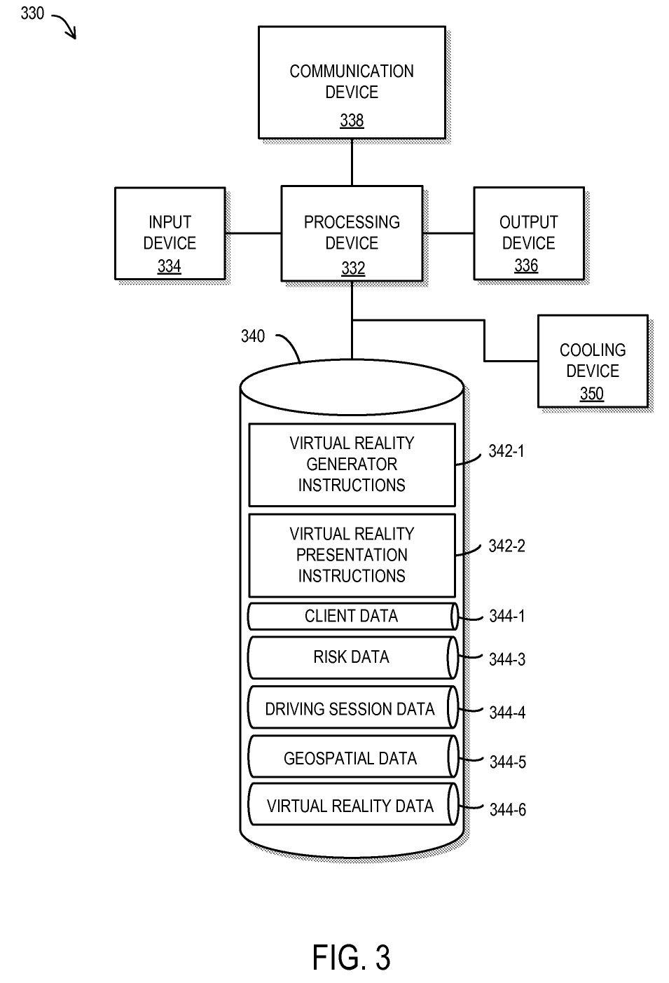

Turning to FIG. 3, a block diagram of an apparatus 330 according to some embodiments is shown. In some embodiments, the apparatus 330 may be similar in configuration and/or functionality to any of the VR user devices 102a-n and/or the virtual reality server 110 of FIG. 1 and/or may comprise a portion of the system 200 of FIG. 2 herein. The apparatus 330 may, for example, execute, process, facilitate, and/or otherwise be associated with methods described in this disclosure. In some embodiments, the apparatus 330 may comprise a processing device 332, an input device 334, an output device 336, a communication device 338, and/or a memory device 340. According to some embodiments, any or all of the components 332, 334, 336, 338, 340 of the apparatus 330 may be similar in configuration and/or functionality to any similarly named and/or numbered components described herein. Fewer or more components 332, 334, 336, 338, 340 and/or various configurations of the components 332, 334, 336, 338, 340 may be included in the apparatus 330 without deviating from the scope of embodiments described herein.

According to some embodiments, the processing device 332 may be or include any type, quantity, and/or configuration of electronic and/or computerized processor that is or becomes known. The processing device 332 may comprise, for example, an Intel® IXP 2800 network processor or an Intel® XEON™ Processor coupled with an Intel® E7501 chipset. In some embodiments, the processing device 332 may comprise multiple inter-connected processors, microprocessors, and/or micro-engines. According to some embodiments, the processing device 332 (and/or the apparatus 330 and/or portions thereof) may be supplied power via a power supply (not shown), such as a battery, an Alternating Current (AC) source, a Direct Current (DC) source, an AC/DC adapter, solar cells, and/or an inertial generator. In the case that the apparatus 330 comprises a server, such as a blade server, necessary power may be supplied via a standard AC outlet, power strip, surge protector, and/or Uninterruptible Power Supply (UPS) device.

In some embodiments, the input device 334 and/or the output device 336 are communicatively coupled to the processing device 332 (e.g., via wired and/or wireless connections and/or pathways) and they may generally comprise any types or configurations of input and output components and/or devices that are or become known, respectively. The input device 334 may comprise, for example, a keyboard that allows an operator of the apparatus 330 to interface with the apparatus 330 (e.g., by a virtual reality application developer, such as to generate a virtual reality application for a user). In some embodiments, the input device 334 may comprise a sensor configured to provide information to the apparatus 330 and/or the processing device 332. The output device 336 may, according to some embodiments, comprise a display screen and/or other practicable output component and/or device. The output device 336 may, for example, provide a customized virtual reality module to a customer or other type of user (e.g., via a website accessible using a user device). According to some embodiments, the input device 334 and/or the output device 336 may comprise and/or be embodied in a single device, such as a touch-screen monitor.

In some embodiments, the communication device 338 may comprise any type or configuration of communication device that is or becomes known or practicable. The communication device 338 may, for example, comprise a network interface card (NIC), a telephonic device, a cellular network device, a router, a hub, a modem, and/or a communications port or cable. In some embodiments, the communication device 338 may be coupled to provide data to a user device and/or virtual reality presentation system (not shown in FIG. 3), such as in the case that the apparatus 330 is utilized to generate and/or serve a customized virtual reality application to a VR user as described herein. The communication device 338 may, for example, comprise a cellular telephone network transmission device that sends signals to a user device. According to some embodiments, the communication device 338 may also or alternatively be coupled to the processing device 332. In some embodiments, the communication device 338 may comprise an IR, RF, Bluetooth™, and/or Wi-Fi® network device coupled to facilitate communications between the processing device 332 and another device (such as a customer device and/or a third-party device).

The memory device 340 may comprise any appropriate information storage device, including, but not limited to, units and/or combinations of magnetic storage devices (e.g., a hard disk drive), optical storage devices, and/or semiconductor memory devices, such as RAM devices, Read Only Memory (ROM) devices, Single Data Rate Random Access Memory (SDR-RAM), Double Data Rate Random Access Memory (DDR-RAM), and/or Programmable Read Only Memory (PROM).

The memory device 340 may, according to some embodiments, store one or more of virtual reality generator instructions 342-1, virtual reality presentation instructions 342-2, client data 344-1, risk data 344-3, driving session data 344-4, geospatial data 344-5, and/or virtual reality data 344-6.

In some embodiments, the virtual reality generator instructions 342-1 may be utilized by the processing device 332 to generate one or more customized virtual scenarios for customers and output the generated virtual reality instructions via the output device 336 and/or the communication device 338.

According to some embodiments, the virtual reality generator instructions 342-1 may be operable to cause the processing device 332 to process client data 344-1, risk data 344-3, driving session data 344-4 (e.g., including telematics data and/or driver distraction data), and/or geospatial data 344-5 (e.g., to generate virtual reality data 344-6). In some embodiments, alternatively or in addition, as described with respect to FIG. 2, claim data and/or loss data may be stored and/or accessed in generating virtual reality presentations. Client data 344-1, risk data 344-3, driving session data 344-4, and/or geospatial data 344-5 received via the input device 334 and/or the communication device 338 may, for example, be analyzed, sorted, filtered, and/or otherwise processed by the processing device 332 in accordance with the virtual reality generator instructions 342-1. In some embodiments, client data 344-1, risk data 344-3, driving session data 344-4, and/or geospatial data 344-5 may be processed by the processing device 332 using a virtual reality development application, engine, and/or software toolkit (e.g., Vizard VP Software Toolkit by WorldViz) in accordance with the virtual reality generator instructions 342-1 to generate a customized virtual reality environment (e.g., incorporating one or more customized VR scenarios) in accordance with one or more embodiments described herein.

In some embodiments, the virtual reality presentation instructions 342-2 may be utilized by the processing device 332 to present one or more customized virtual scenarios for users via one or more output devices. For example, the virtual reality presentation instructions 342-2 may be embodied as a client application installed on a user device such as a personal computer, smartphone or other mobile device, or dedicated VR computer terminal. Alternatively, or in addition, the virtual reality presentation instructions 342-2 may be made available as a server-, network-, and/or web-based application executable via a client computer.

Any or all of the exemplary instructions and data types described herein and other practicable types of data may be stored in any number, type, and/or configuration of memory devices that is or becomes known. The memory device 340 may, for example, comprise one or more data tables or files, databases, table spaces, registers, and/or other storage structures. In some embodiments, multiple databases and/or storage structures (and/or multiple memory devices 340) may be utilized to store information associated with the apparatus 330. According to some embodiments, the memory device 340 may be incorporated into and/or otherwise coupled to the apparatus 330 (e.g., as shown) or may simply be accessible to the apparatus 330 (e.g., externally located and/or situated).

In some embodiments, the apparatus 330 may comprise a cooling device 350. According to some embodiments, the cooling device 350 may be coupled (physically, thermally, and/or electrically) to the processing device 332 and/or to the memory device 340. The cooling device 350 may, for example, comprise a fan, heat sink, heat pipe, radiator, cold plate, and/or other cooling component or device or combinations thereof, configured to remove heat from portions or components of the apparatus 330.

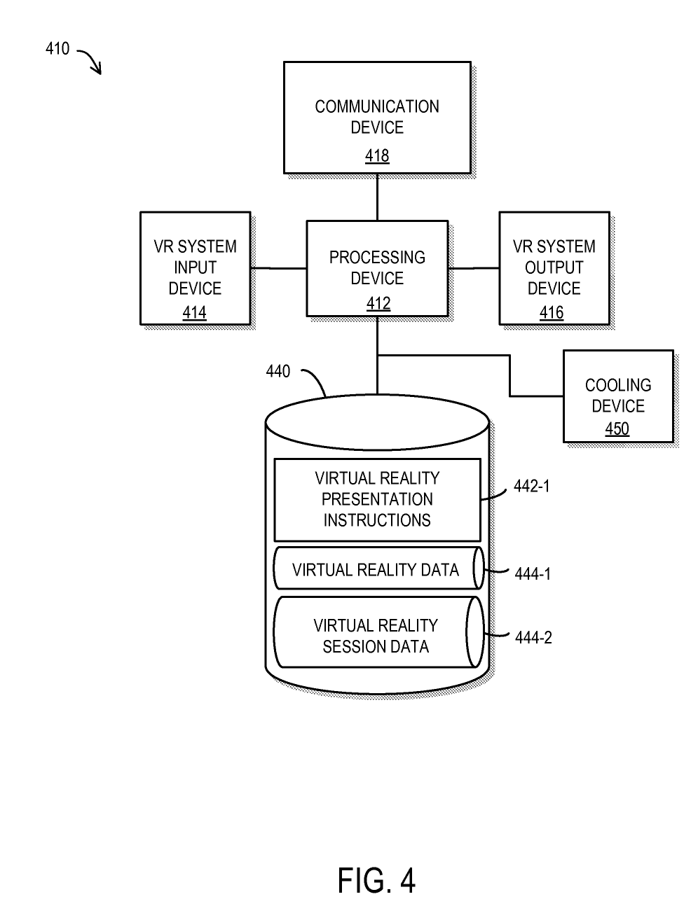

Turning to FIG. 4, a block diagram of an apparatus 410 according to some embodiments is shown. In some embodiments, the apparatus 410 may be similar in configuration and/or functionality to any of the VR user devices 102a-n, the virtual reality server 110, and/or may comprise a portion of the system 200 (e.g., of virtual reality presentation system 220). The apparatus 410 may, for example, execute, process, facilitate, and/or otherwise be associated with methods described in this disclosure. In some embodiments, the apparatus 410 may comprise a processing device 412, VR system input device 414, VR system output device 416, a communication device 418, and/or a memory device 440. According to some embodiments, any or all of the components 412, 414, 416, 418, 440 of the apparatus 410 may be similar in configuration and/or functionality to any similarly named and/or numbered components described herein. Fewer or more components 412, 414, 416, 418, 440 and/or various configurations of the components 412, 414, 416, 418, 440 may be included in the apparatus 410 without deviating from the scope of embodiments described herein.

The memory device 440 may, according to some embodiments, store one or more of virtual reality presentation instructions 442-1, virtual reality data 444-1, and/or virtual reality session data 444-2. In some embodiments, the virtual reality presentation instructions 442-1 may be utilized by the processing device 412 to present one or more customized virtual scenarios for customers using one or more VR system output devices and/or to receive and store virtual reality session data 444-2 based on monitoring actions of a user in a virtual environment. For example, the virtual reality presentation instructions 442-1 may be embodied as a client application installed on a VR user device such as a personal computer, smartphone or other mobile device, or a dedicated VR computer terminal. Alternatively, or in addition, the virtual reality presentation instructions 442-2 may be made available as a server-, network-, and/or web-based application executable (e.g., via a browser application) on a laptop or other type of user computer.

According to some embodiments, VR system input device 414 may comprise one or more types of input devices for a user to provide input to a VR system. Various types of VR input devices are known to those skilled in the relevant art, and examples include, without limitation, motion sensors (e.g., stand-alone or integrated with gloves, HMDs, etc.), motion capture devices, haptic input devices, head tracking devices, joysticks, keyboards, touchscreen displays, eye tracking devices, and the like. Similarly, VR system output device 416 may comprise one or more display and/or audio devices and/or other types of output devices known to those skilled in the art, including, but not limited to, speakers, force feedback devices (e.g., integrated in a glove or joystick), projection systems (e.g., CAVE, Powerwall, 3-D projection), stereoscopic displays, and HMDs (e.g., nVisor SX60 HMD by nVis).

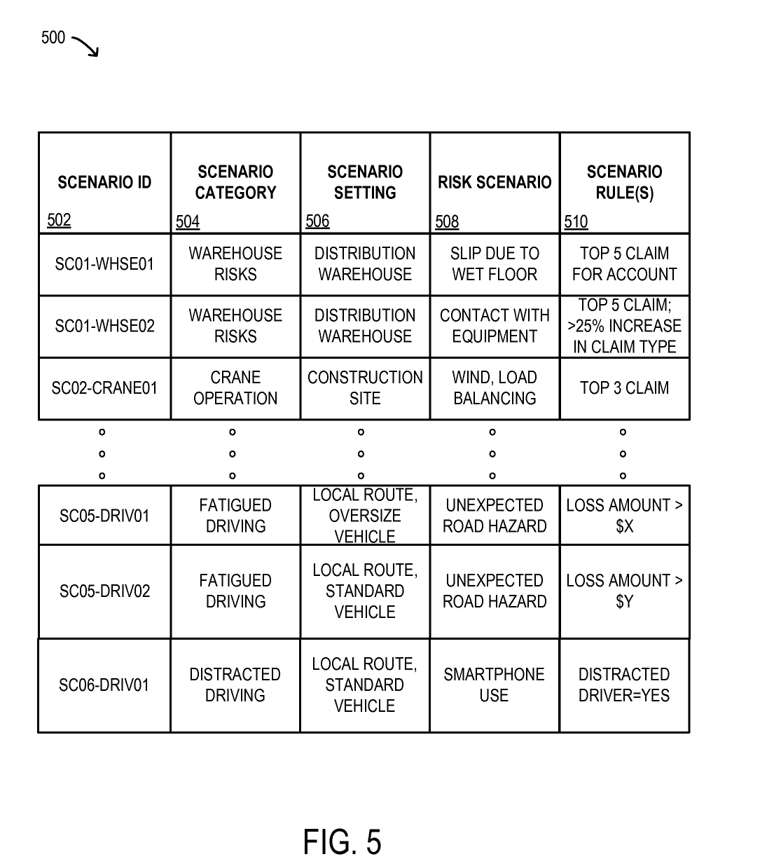

Referring to FIG. 5, a diagram of an example data storage structure 500 according to some embodiments is shown. In some embodiments, the data storage structure 500 may comprise VR scenario data for use in generating customized virtual reality modules for one or more particular VR users (e.g., customers, drivers, employees, etc.). The example data fields include scenario ID 502 identifying a particular virtual reality scenario, scenario category 504 describing a category or type of the VR scenario, scenario setting 506 describing a setting for the respective scenario (e.g., a type of business location or driving environment), a risk scenario 508 that describes the type of exposure or risk presented in the respective scenario, and one or more scenario rules 510 describing example conditions that may need to be met (e.g., by corresponding entity and/or user data) in order for the scenario to be utilized in generating a customized virtual reality scenario for a particular user.

According to one embodiment, a crane operation scenario (e.g., “SC02-CRANE01”) may be made available (e.g., in a database of available VR scenarios). The crane operation scenario may be associated, for example, with an example condition that insurance claims related to crane operation are among the three most common types of claims for a particular entity (e.g., a business customer). In one example, a crane operation scenario may be associated, for example, with a construction site or other type of environment in which a crane may operate. In another example, a crane operation-type scenario may represent one or more types of risk scenarios involving crane operation by simulating crane operation under certain load conditions and/or environmental conditions (e.g., wind speed).

According to one embodiment, a distracted driving scenario (e.g., “SC06-DRIV01”) may be made available (e.g., in a database of available VR scenarios), the distracted driving scenario being associated with an example condition that a driver has been determined (e.g., based on a review of recorded information from a driving session of the driver) to be a distracted driver. For example, all or a portion of a driving session (whether virtual or real) of a driver may be recorded (e.g., using audio and/or video recording equipment for a real or virtual environment, telematics devices in a real vehicle, etc.) and analyzed (e.g., automatically by a VR server and/or by a human operator) to identify one or more behaviors, events, actions, and/or inactions that may be helpful in generating a virtual driving simulation (e.g., for that driver and/or for one or more other VR users) to demonstrate hazards of distracted driving. In one example, if a user is identified as a distracted driver or at risk of being a distracted driver, the user may be flagged in a database (e.g., a database of employees and/or VR users).

In some embodiments, fewer or more data fields than are shown may be associated with the example data table 500. Other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein.

According to some embodiments, processes described in this disclosure may be performed and/or implemented by and/or otherwise associated with one or more specialized and/or computerized processing devices, specialized computers, computer terminals, computer servers, computer systems, and/or networks, and/or any combinations thereof. In some embodiments, methods may be embodied in, facilitated by, and/or otherwise associated with various input mechanisms and/or interfaces.

Any processes described in this disclosure do not necessarily imply a fixed order to any depicted actions, steps, and/or procedures, and embodiments may generally be performed in any order that is practicable unless otherwise and specifically noted. Any of the processes and/or methods described in this disclosure may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described in this disclosure.

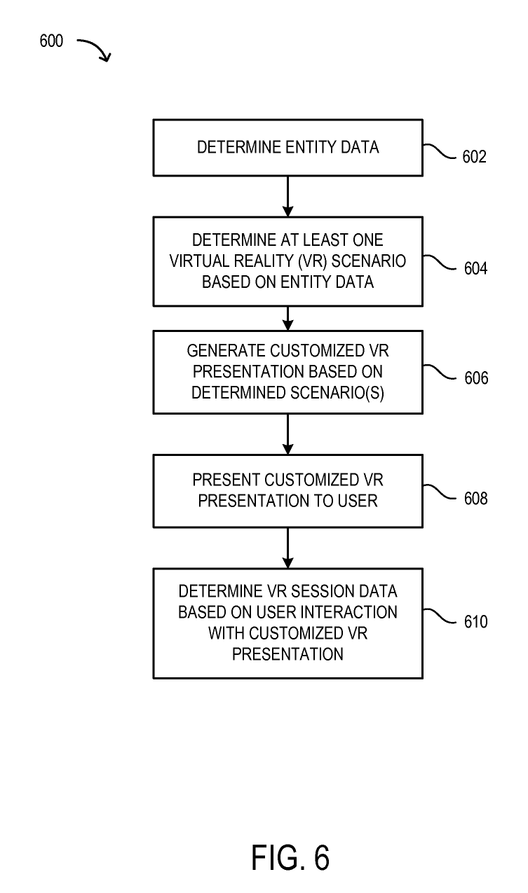

Referring now to FIG. 6, a flow diagram of a method 600 according to some embodiments is shown. The method 600 may be performed, for example, by a server computer. It should be noted that although some of the steps of method 600 may be described as being performed by a server computer (e.g., a virtual reality server), while other steps are described as being performed by another computing device, any and all of the steps may be performed by a single computing device, which may be a mobile device, desktop computer, or another computing device. Further, any steps described herein as being performed by a particular computing device may, in some embodiments, be performed by a human or another computing device as appropriate.

According to some embodiments, the method 600 may comprise determining entity data (e.g., data associated with a customer, employee, business, etc.), at 602. In some embodiments, determining entity data may comprise determining one or more of VR user data, employee data, business data (e.g., policy data, claim data, loss data), exposure data, driving session data (e.g., driving conditions data, driver distraction data, and/or telematics data), and/or geospatial data (e.g., corresponding to a place of business). According to some embodiments, the method 600 may further comprise determining at least one virtual reality (VR) scenario based on the entity data, at 604. As discussed in this disclosure, one or more VR scenarios may be selected based on driver session data, driver distraction analysis, loss mitigation analysis, and/or other types of customizations based on information related to an employee, driver, customer, or other type of entity.

According to some embodiments, the method 600 may further comprise generating a customized VR presentation based on the determined scenario(s), at 606. For example, a VR rendering control program may generate a virtual environment based on particular programmatic objects corresponding to the one or more determined scenarios. The method 600 may comprise presenting the customized VR presentation to a user (e.g., via a HMD or Powerwall display), at 608. For example, the user (who may be the person associated with the entity data) may participate in the customized VR presentation (e.g., a customized training program based on common accident types).

The method 600 may comprise determining VR session data based on interactions of the user with the customized VR presentation, at 610. For example, user monitoring procedure 220-2 may capture and transmit information about the user's actions and behavior in the virtual environment of the customized VR presentation.

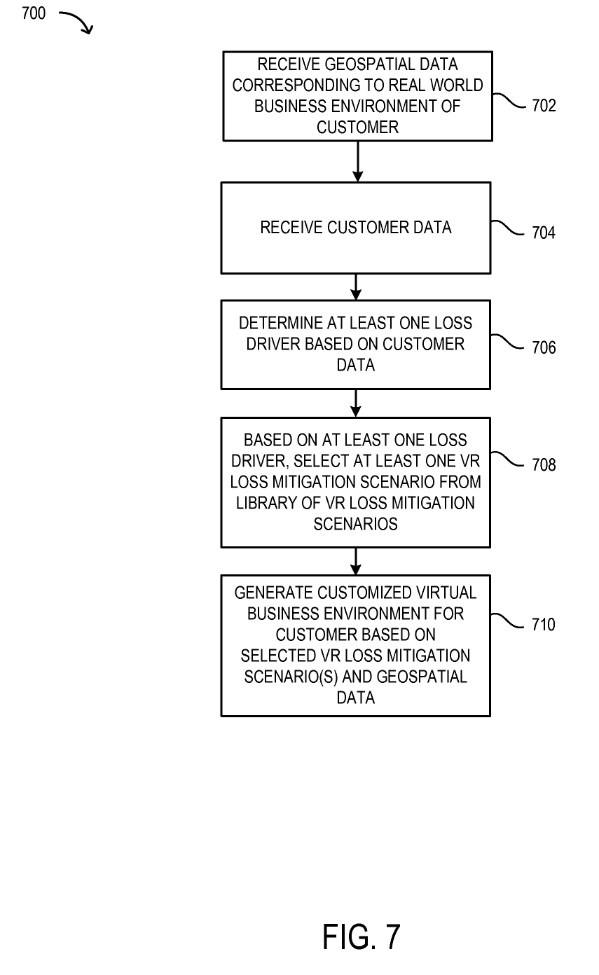

Referring now to FIG. 7, a flow diagram of a method 700 according to some embodiments is shown. The method 700 may be performed, for example, by a server computer. It should be noted that although some of the steps of method 700 may be described as being performed by a server computer (e.g., a virtual reality server) while other steps are described as being performed by another computing device, any and all of the steps may be performed by a single computing device which may be a mobile device, desktop computer, or another computing device. Further any steps described herein as being performed by a particular computing device may, in some embodiments, be performed by a human or another computing device as appropriate.

According to some embodiments, the method 700 may comprise receiving geospatial data corresponding to a real world business environment of a customer, at 702, and receiving customer data (e.g., employee data, business data, claim data, loss data, and/or risk management data), at 704.

According to some embodiments, the method 700 may comprise determining at least one loss driver based on the customer data, at 706. In one embodiment, loss mitigation analysis procedure 242b may be used to identify relevant loss drivers based on the customer's claim history. The method 700 may further comprise, based on the at least one loss driver, selecting at least one VR loss mitigation scenario from a library of VR loss mitigation scenarios, at 708. According to some embodiments, the method 700 may comprise generating a customized virtual business environment for the customer, based on the selected VR loss mitigation scenario(s) and the geospatial data, at 710. Accordingly, a customer may be presented with a customized VR experience that is customized in terms of the scenarios it includes and the virtual setting corresponding to the customer's real world business environment.

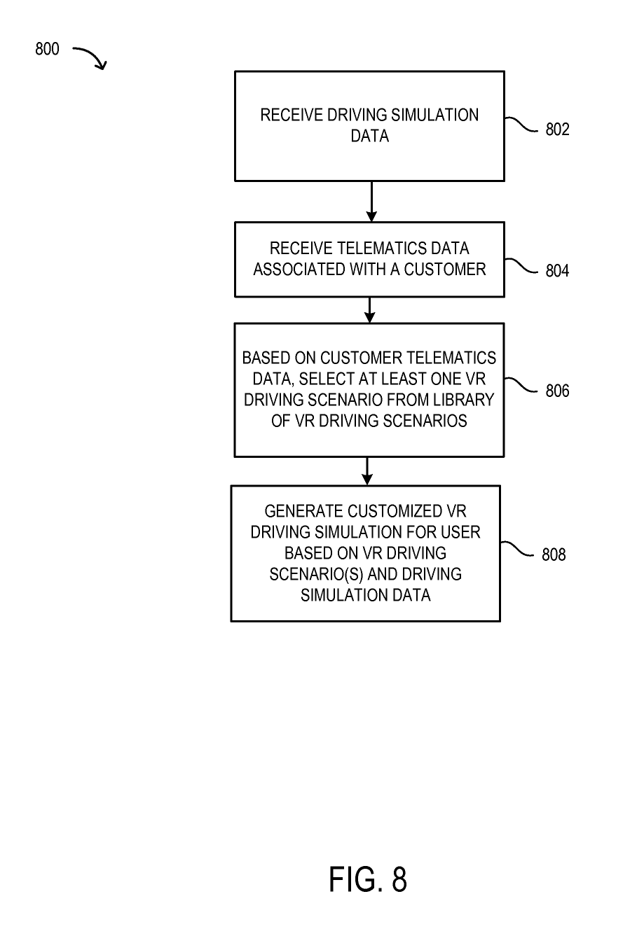

Referring now to FIG. 8, a flow diagram of a method 800 according to some embodiments is shown. The method 800 may be performed, for example, by a server computer. It should be noted that although some of the steps of method 800 may be described as being performed by a server computer (e.g., a virtual reality server) while other steps are described as being performed by another computing device, any and all of the steps may be performed by a single computing device which may be a mobile device, desktop computer, or another computing device. Further any steps described herein as being performed by a particular computing device may, in some embodiments, be performed by a human or another computing device as appropriate.

According to some embodiments, the method 800 may comprise receiving driving simulation data (e.g., driving condition data, driver condition data, driver distraction data, and/or vehicle data), at 802. As discussed with respect to some embodiments in this disclosure, a VR experience may comprise a driving simulation or, with regard to certain types of equipment, an operational simulation. For such examples, reference to the term “driving” includes operation of the equipment and/or vehicle. The driving simulation may be based on data describing particular simulated driving conditions (e.g., weather conditions), driver distractions, simulated driver conditions (e.g., driver fatigue and/or other impairment), and/or simulated vehicle data (e.g., virtual objects for simulating various types of vehicles and/or loads).

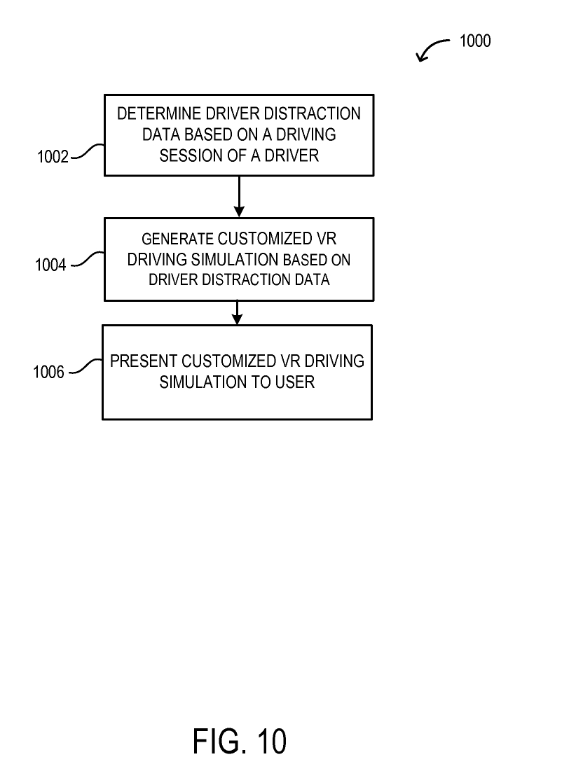

The method 800 may further comprise receiving telematics data associated with a customer, at 804. Various sources and types of such data are described with respect to FIG. 2 and elsewhere in this disclosure. According to some embodiments, the method 800 may further comprise, based on the user telematics data, selecting at least one VR driving scenario from a library of VR driving scenarios, at 806. In one example, one or more VR scenarios including simulated driving scenarios (e.g., depicting unexpected weather and/or road conditions) may be selected based on a business customer's insurance claim history and/or a user's driving habits (e.g., as represented in the telematics data). According to some embodiments, telematics data may be recorded in a vehicle and uploaded to a VR server and/or computer for VR presentation generation. This information may be used (e.g., in accordance with VR presentation generation instructions) to re-create virtually the same or similar circumstances in a VR vehicle in a VR driving simulation, so that the driver, operator, or other VR user may experience a similar driving situation (e.g., with voiceovers). In this way, a VR environment may be created to mirror an actual operator's or driver's circumstances (e.g., for a particular driving session or driving accident) and/or behaviors. In some embodiments, vehicle speeds, driver distractions, and other vehicles, for example, may be represented virtually in the VR presentation to mirror recorded behaviors. In some embodiments, discussed in more detail with respect to FIG. 10 and example VR user interfaces 11A and 11B, a generated VR environment may also simulate a driver's looking away, to make a VR user (who may be the actual driver recorded) aware of how much may be missed during a time when a driver is distracted, and how often that may occur.

The method 800 may further comprise generating a customized VR driving simulation for a user (e.g., an employee of a business) based on the VR driving scenario(s) and the driving simulation data, at 808. For example, the generated VR experience may include an interactive driving simulation allowing employees of a company to simulate driving in hazardous road conditions while in a fatigued state.

According to some embodiments, the method 800 may comprise (alternatively or in addition) receiving business customer data (e.g., insurance customer data) including claim data, loss data, and/or risk management data. According to some embodiments, selecting the at least one VR driving scenario may be based on such business customer data.

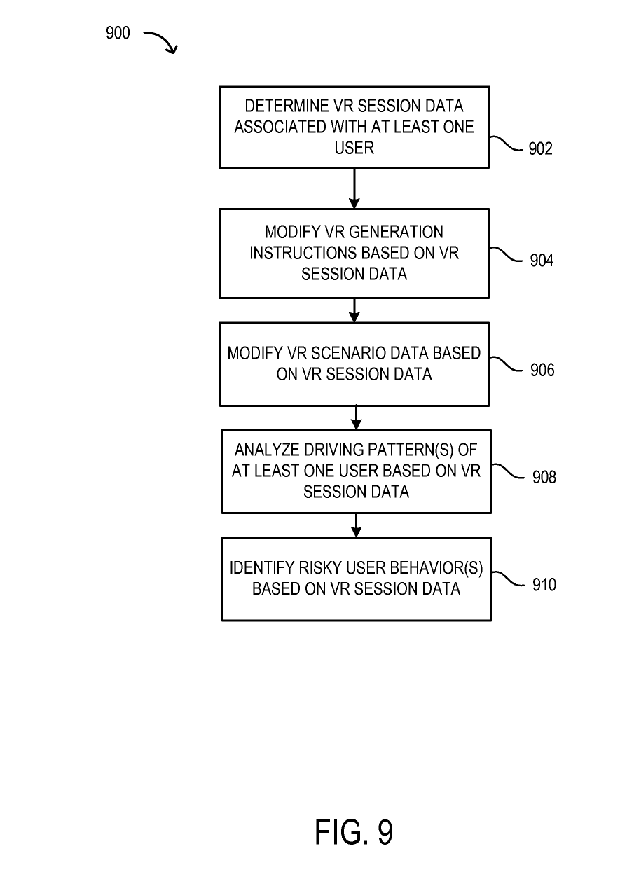

Referring now to FIG. 9, a flow diagram of a method 900 according to some embodiments is shown. The method 900 may be performed, for example, by a server computer. It should be noted that although some of the steps of method 900 may be described as being performed by a server computer (e.g., a virtual reality server) while other steps are described as being performed by another computing device, any and all of the steps may be performed by a single computing device which may be a mobile device, desktop computer, or another computing device. Further any steps described herein as being performed by a particular computing device may, in some embodiments, be performed by a human or another computing device as appropriate.

The method 900 describes various types of analyses and/or determinations that may be made based on user session data. As with the other methods described in this disclosure, not all of the steps are necessary for any particular embodiment. According to some embodiments, the method 900 may comprise determining VR session data associated with at least one user, at 902. In one example, user session data describing user actions while participating in a VR experience may be stored in and/or accessed from user session data 244e. The method 900 may further comprise modifying VR generation instructions based on the VR session data, at 904, and/or modifying VR scenario data based on the VR session data, at 906. As discussed with respect to various embodiments, VR user session data may be utilized, as desired, to iterate VR generation program logic and/or to add, remove, and/or modify VR scenarios (e.g., based on user feedback).

According to some embodiments, the method 900 may comprise analyzing driving pattern(s) of at least one user based on the VR session data, at 908. For example, the actions taken by a business customer's employee drivers during a VR driving simulation may be analyzed to determine behavior trends, driving errors, and/or risky driving behavior. According to some embodiments, the method 900 may comprise identifying risky user behavior(s) based on the VR session data, at 910.

According to some embodiments, the method 900 may further comprise determining an insurance premium for a customer based on the VR session data. For example, a customer's insurance premium may be based on the actions the customer took in a simulated environment (e.g., a simulated training program). For instance, the premium determined may be relatively higher if the customer engaged in more risky behavior or failed to recognize hazardous conditions.

Referring now to FIG. 10, a flow diagram of a method 1000 according to some embodiments is shown. The method 1000 may be performed, for example, by a server computer. It should be noted that although some of the steps of method 1000 may be described as being performed by a server computer (e.g., a virtual reality server) while other steps are described as being performed by another computing device, any and all of the steps may be performed by a single computing device which may be a mobile device, desktop computer, or another computing device. Further any steps described herein as being performed by a particular computing device may, in some embodiments, be performed by a human or another computing device as appropriate.

According to some embodiments, the method 1000 may comprise determining driver distraction data based on a driving session of a driver, at 1002. As discussed with respect to some embodiments in this disclosure, information about a driver's driving session (a virtual or real world driving session), including driver distraction data, may be recorded, stored, and/or analyzed, and utilized to generate a VR driving simulation. Various sources and types of such data are described with respect to FIG. 2 and elsewhere in this disclosure.

According to some embodiments, the method 1000 may further comprise, generate customized VR driving simulation based on the driver distraction data, at 1004. In some embodiments, one or more VR driving scenarios (e.g., depicting distraction events and/or conditions, unexpected weather and/or road conditions) may be selected based on the driver distraction data. The method 1000 may further comprise presenting the customized VR driving simulation to a user (who may be the same or different than the driver). For example, the generated VR driving simulation may allow an employee of a company to simulate the effect of distractions on a driver's ability to drive safely and appropriately.

Any or all the methods described in this disclosure may involve one or more interface(s). One or more of such methods may include, in some embodiments, providing an interface by and/or through which a user may (i) initiate a VR experience generation process, (ii) review loss mitigation analysis data, (iii) generate, review, and/or select available VR scenarios and/or settings for use in a customized VR experience, and/or (iv) participate in a customized VR experience. Those skilled in the art will understand that interfaces may be modified in order to provide for additional types of information and/or to remove some of types of information, as deemed desirable for a particular implementation.

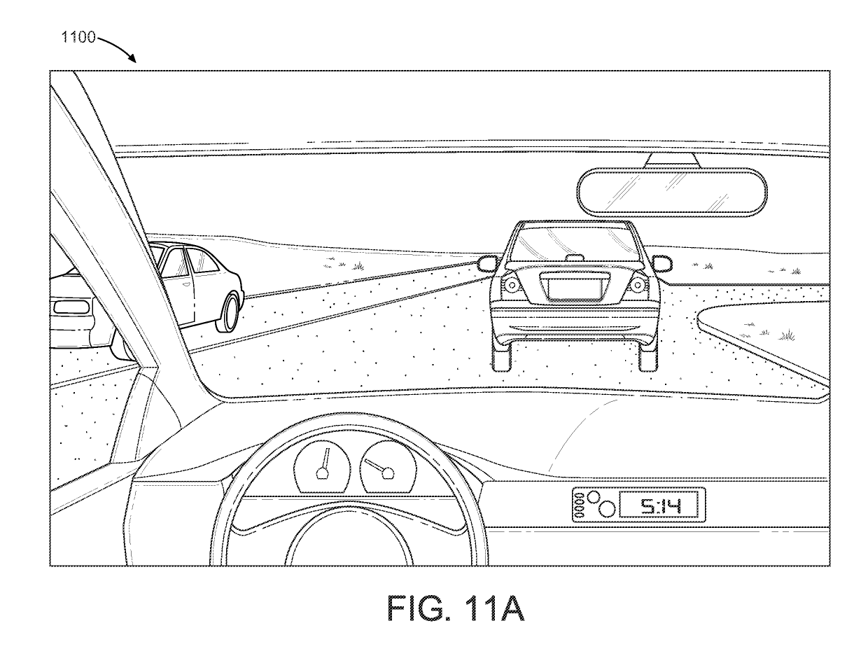

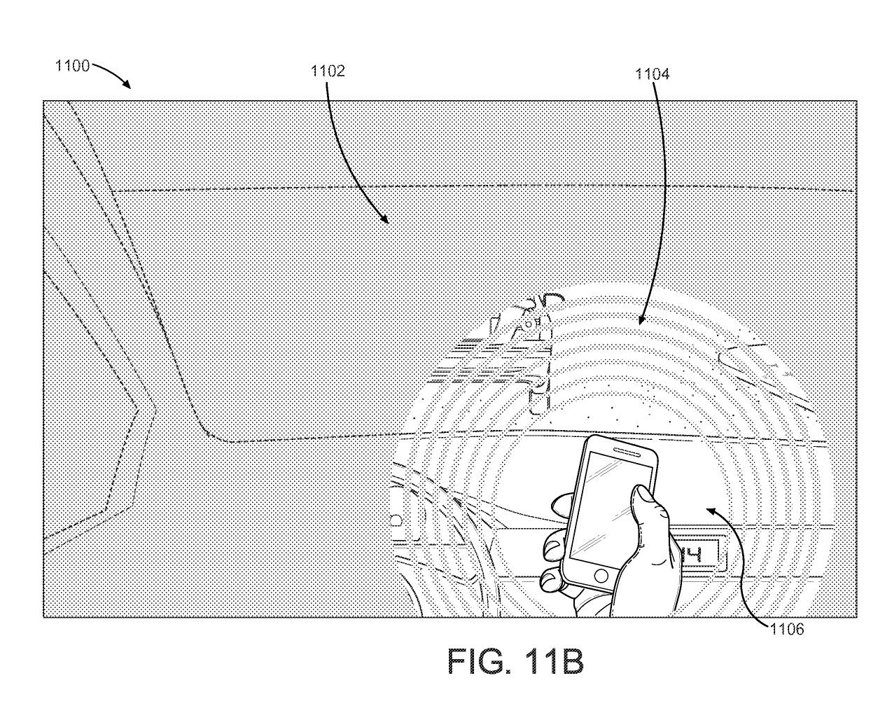

FIGS. 11A and 11B depict example VR driving simulations and/or VR user interfaces 1100, according to some embodiments. In some embodiments, as discussed in this disclosure, a VR user device may comprise one or more display output devices (e.g., a computer monitor, a table computer's display screen) that outputs on or more of the example user interfaces 1100. As depicted in FIG. 11A, VR user interface 1100 may comprise a VR image representing a driving experience from a driver's perspective. As will be readily understood, the VR driving simulation may allow a VR user to interact with the simulation, to control various aspects and objects of the VR environment, such as accelerating or braking the vehicle, operating vehicle controls, changing the virtual driver's view (e.g., by the user physically moving his head), and the like. In one embodiment, the example VR user interface depicted in FIG. 11A may be representative of a distraction-free driving environment.

As depicted in FIG. 11B, VR user interface 1100 may represent a distracted driving environment virtually, in which the VR user's view is other than directly or substantially ahead (e.g., to view the road), and/or in which the VR user's view is focused on a distracting portion 1106 of the available VR environment including an object associated with distracted driving (e.g., a smartphone), or representative of a distracting activity (e.g., sending or view text messages on a smartphone). As depicted in FIG. 11B, the VR user interface 1100 may, in some embodiments, be configured to represent a driver's relative inability to see or experience other portions of the VR environment while focused on the distracting portion 1106. According to the example in FIG. 11B, the portions 1102 and 1104 may be represented as fully obscured or partially obscured, respectively, in order to demonstrate the loss of focus and vision created by a distraction. According to some embodiments, in addition to or in place of the visual cues such as in FIG. 11B, one or more messages (e.g., displayed messages, voiceover/audio messages) may be presented to a VR user, via a display device and/or an audio device, to indicate to the VR user what behaviors may be represented in a VR user interface.

In addition to or in lieu of driver distraction data, other types of driver behavior may be represented in a VR presentation, such as incorporating data recorded by in-vehicle telematics systems into a VR driving simulation, to demonstrate to drivers and operators mistakes in operating vehicles and other machines.

In accordance with some embodiments, customized virtual reality applications may be used for assisting injured persons with pain management (e.g., during recovery from injury) to reduce addiction and/or with injury recovery (e.g., promoting adherence to physical therapy during sustained treatment). In some embodiments, occupational therapy may be provided via a simulated virtual reality environment. In accordance with some embodiments, customized virtual reality applications may be used for facilitating a transition of an injured person back into the workplace (e.g., by providing for a simulated visualization of the workplace and/or a new job function).

Although various embodiments are discussed in this disclosure as involving customers (e.g., workers, employees of an insurance customer) as participants in a virtual reality experience, it will be readily understood that customized virtual reality experiences may be presented to and/or experienced by other types of users, including users who may have no previous affiliation or relationship with a customer or with an entity operating and/or generating customized VR presentations (e.g., a member of the public). In some embodiments, customized virtual reality environments may be generated based on one or more types of information related to one or more customers (e.g., insurance customers), and the customized environment may then be experienced by the customer and/or by one or more other types of users (e.g., claim professionals, risk managers, underwriters, auditors, agents, business managers, medical professionals). Accordingly, where VR experiences are described as having customers participate in the experience, it will be readily understood that this disclosure also contemplates other types of users interacting with the customized VR environment.

In accordance with some embodiments, customized virtual reality applications may be used for reenacting and/or reconstructing accidents (e.g., based on telematics data) or catastrophes (e.g., tornadoes, hurricanes, floods, fires, etc.), which may be useful as a training resource for customers (e.g., to allow employees to visualize and/or experience accident and/or loss conditions) and/or other types of users (e.g., for insurance professionals to better understand hazardous conditions, risky behaviors, etc.). For example, conditions and/or events related to an accident may be rendered as an interactive virtual experience.

In accordance with some embodiments, customized virtual reality applications may be useful for one or more of: simulating various types of claim scenarios (e.g., as an education resource for claim professionals); providing users (e.g., insurance professionals, nurses and other types of medical professionals) with a better understanding of types of injuries and/or types of pain; post-traumatic event therapy for users (e.g., to help employees, first responders, insurance professionals, etc., recover after a significant loss event and/or fatality); simulation of potential products; and/or improving the situational awareness and/or understanding of audit professionals. In one example, insurance and/or medical professionals may participate in a VR experience customized to simulate the causes and/or physical effects of one or more types of injuries and/or pain (e.g., injuries selected because of their common occurrence in a particular industry based on loss mitigation analysis). For instance, a VR environment may include a scenario in which a user's ability to virtually lift a box or perform another virtual action is restricted or limited in order to represent the effect of an injury and/or pain experienced by a worker. Output devices in the VR system may provide effects (e.g., force feedback, auditory signals, visual impairment, etc.) designed to simulate a “painful” experience when performing certain actions. Accordingly, workers, insurance professionals, and other types of users may receive valuable insight into the effect that pain and injury may have on performance, quality of life, etc.

### Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The phrase “based on” does not mean “based only on”, unless expressly specified otherwise. In other words, the phrase “based on” describes both “based only on” and “based at least on”.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format, such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “computer-readable memory device”, and/or “tangible media” specifically exclude signals, waves, and wave forms or other intangible or transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to an environment wherein one or more computing devices may communicate with one another, and/or to any object, entity, component, device, and/or any combination thereof that permits, facilitates, and/or otherwise contributes to or is associated with the transmission of messages, packets, signals, and/or other forms of information between and/or within one or more network devices. Such devices may communicate directly or indirectly, via a wired or wireless medium, such as the Internet, LAN, WAN or Ethernet (or IEEE 802.3), Token Ring, or via any appropriate communications means or combination of communications means. In some embodiments, a network may include one or more wired and/or wireless networks operated in accordance with any communication standard or protocol that is or becomes known or practicable. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), the Fast Ethernet LAN transmission standard 802.3-2002® published by the Institute of Electrical and Electronics Engineers (IEEE), or the like. Networks may be or include a plurality of interconnected network devices. In some embodiments, networks may be hard-wired, wireless, virtual, neural, and/or any other configuration of type that is or becomes known. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures, such as logins and passwords may be provided to protect proprietary or confidential information.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer-readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

What is claimed is:

1. A system for providing virtual reality presentations, the system comprising:
a display output device for displaying at least one virtual reality image for a customized virtual reality presentation; and
a virtual reality server in communication with the display output device, the virtual reality server comprising:
a processor; and
a computer-readable memory in communication with the processor, the computer-readable memory storing instructions for generating customized virtual reality presentations, that when executed by the processor direct the processor to:
determine data associated with an entity;
select, from a plurality of available virtual reality scenarios and based on the determined data associated with the entity, at least one virtual reality scenario;
generate a customized virtual reality presentation including at least one virtual reality image, based on the at least one selected virtual reality scenario and the determined data associated with the entity; and
present, via the display output device, the customized virtual reality presentation to a user.

2. The system of claim 1, further comprising:
an audio output device for outputting audio for a customized virtual reality presentation; and
a user input device for receiving input from a user during a customized virtual reality presentation.

3. The system of claim 1, wherein the data associated with the entity comprises driving session data associated with a previous driving session by the entity; and
wherein selecting the at least one virtual reality scenario from the plurality of available virtual reality scenarios comprises:
selecting, based on the driving simulation data, at least one virtual reality driving scenario from a database of virtual reality driving scenarios.

4. The system of claim 1,
wherein the data associated with the entity comprises driver distraction data associated with a previous driving session by the user; and
wherein selecting the at least one virtual reality scenario from the plurality of available virtual reality scenarios comprises:
selecting, based on the driver distraction data, at least one virtual reality driving scenario from a database of virtual reality driving scenarios; and
wherein generating the customized virtual reality presentation comprises:
generating the customized virtual reality presentation based on the selected at least one virtual reality driving scenario and the driver distraction data.

5. The system of claim 1, wherein the data associated with the entity comprises one or more of the following types of driving simulation data: driving condition data, driver condition data, and vehicle data.

6. The system of claim 5, wherein the vehicle data describes one or more of the following:
a type of automobile,
a type of truck,
a type of construction vehicle,
a type of maritime vessel, and
a type of aircraft.

7. The system of claim 5, wherein the driving condition data describes one or more of the following:
road conditions,
environmental conditions data,
environmental obstacles data,
structures data,
weather conditions, and
equipment conditions.

8. The system of claim 1, wherein the data associated with the entity comprises telematics data associated with a vehicle driven by the entity.

9. The system of claim 1, wherein the instructions when executed by the processor further direct the processor to:
determine virtual reality session data based on interaction of the user with the customized virtual reality presentation.

10. A system for simulating driver distractions in virtual reality driving simulations, the system comprising:
a display output device for displaying at least one virtual reality image for a customized virtual reality driving simulation;
a user input device for receiving input from a user during a customized virtual reality driving simulation; and
a virtual reality server in communication with the display output device and with the user input device, the virtual reality server comprising:
a processor; and
a computer-readable memory in communication with the processor, the computer-readable memory storing instructions for generating customized virtual reality driving simulations, that when executed by the processor direct the processor to:
receive driving session data associated with at least one previous driving session of a driver, wherein the driving session data associated with the first driver comprises driver distraction data;
select, based on the driving session data, a virtual reality driving scenario from a database of virtual reality driving scenarios;
generate a customized virtual reality driving simulation based on the selected at least one virtual reality driving scenario and the driver distraction data; and
present, via the display output device, the customized virtual reality driving simulation to a user.

11. The system of claim 10, wherein the driver distraction data comprises indications of one or more of the following:
a shift of the driver's eye gaze away from a view of a road during a previous driving session, the driver's view during a previous driving session,
a driving error made by the driver during a previous driving session,
an action taken by the driver during a previous driving session, and
an object interacted with by the driver during a previous driving session.

12. The system of claim 10, wherein generating the customized virtual reality driving simulation comprises:
generating, based on the driver distraction data, a virtual reality image representative of the driver's view during a time of the previous driving session when the driver was distracted.

13. The system of claim 10, wherein generating the customized virtual reality driving simulation comprises:
generating, based on the driver distraction data, a virtual reality image representative of a view the driver could not see during a time of the previous driving session when the driver was distracted.

14. The system of claim 10, wherein generating the customized virtual reality driving simulation comprises:
generating, based on the driver distraction data, a first virtual reality image representative of the driver's view during a time of the previous driving session when the driver was distracted; and
generating, based on the driver distraction data, a second virtual reality image representative of a view the driver could not see during a time of the previous driving session when the driver was distracted.

15. The system of claim 10, wherein generating the customized virtual reality driving simulation comprises:
generating, based on the driver distraction data, a virtual reality image representative of an action taken by the driver during a time of the previous driving session when the driver was distracted.

16. The system of claim 10, wherein generating the customized virtual reality driving simulation comprises:
generating, based on the driver distraction data, a virtual reality image representative of an object interacted with by the driver during a previous driving session when the driver was distracted.

17. The system of claim 10, wherein the driving session data comprises information based on a real world driving session of the driver.

18. The system of claim 10, wherein the driving session data comprises information based on a virtual reality driving simulation previously presented to the driver.

19. The system of claim 10, wherein the driving session data further includes one or more of the following types: driving condition data, driver condition data, vehicle data, and telematics data.

20. The system of claim 10, wherein the user is the driver for the at least one previous driving session.

21. A method for simulating driver distractions in virtual reality driving simulations, the method comprising:
receiving, by a virtual reality server storing instructions for generating customized virtual reality driving simulations, driving session data associated with at least one previous driving session of a driver, wherein the driving session data associated with the first driver comprises driver distraction data;
selecting, by the virtual reality server and based on the driving session data, a virtual reality driving scenario from a database of virtual reality driving scenarios;
generating, by the virtual reality server in accordance with the instructions for generating customized virtual reality driving simulations, a customized virtual reality driving simulation based on the selected at least one virtual reality driving scenario and the driver distraction data; and
presenting, by the virtual reality server via the display output device, the customized virtual reality driving simulation to a user.

22. The method of claim 21, wherein the driver distraction data comprises an indication of one or more of the following:
a shift of the driver's eye gaze away from a view of a road during a previous driving session, the driver's view during a previous driving session,
a driving error made by the driver during a previous driving session,
an action taken by the driver during a previous driving session, and
an object interacted with by the driver during a previous driving session.

23. The method of claim 21, wherein generating the customized virtual reality driving simulation comprises:
generating, based on the driver distraction data, a virtual reality image representative of the driver's view during a time of the previous driving session when the driver was distracted.

24. The method of claim 21, wherein generating the customized virtual reality driving simulation comprises:
generating, based on the driver distraction data, a virtual reality image representative of a view the driver could not see during a time of the previous driving session when the driver was distracted.

25. The method of claim 21, wherein generating the customized virtual reality driving simulation comprises:
generating, based on the driver distraction data, a virtual reality image representative of an action taken by the driver during a time of the previous driving session when the driver was distracted.
